(19) United States
(12) Patent Application Publication
(10) Pub. No.: US 2026/0109572 A1
(43) Pub. Date: Apr. 23, 2026

(54) PREDICTIVE MAINTENANCE ADVISORY FOR ELEVATORS

(71) Applicant: TK ELEVATOR INNOVATION AND OPERATIONS GMBH, Düsseldorf (DE)

(72) Inventor: Christian Jung, Ratingen (DE)

(73) Assignee: TK ELEVATOR INNOVATION AND OPERATIONS GMBH, Düsseldorf (DE)

(21) Appl. No.: 19/114,277

(22) PCT Filed: Oct. 4, 2023
(86) PCT No.: PCT/EP2023/077446

§ 371 Date: Mar. 22, 2025

Related U.S. Application Data
(60) Provisional application No. 63/378,646, filed on Oct. 6, 2022.

(51) Int. Cl. B66B 5/00; G06N 3/09

(52) U.S. Cl. CPC B66B 5/0025; G06N 3/09

(57) ABSTRACT

Embodiments of the present disclosure are directed to a computing device comprising processors configured to receive training data comprising elevator data associated with a plurality of elevator assemblies indicating a series of actions performed by an elevator car, receive alert data associated with the elevator assemblies indicating alerts generated by sensors, determine health scores for the elevator assemblies based on the alert data, label the training data based on the health scores to generate first labeled training data, train a first machine learning model, using the first labeled training data and supervised learning techniques, to predict a health score for an elevator based on input elevator data, receive first elevator data associated with a first elevator, input the first elevator data into the trained first machine learning model, and determine a health score associated with the first elevator based on an output of the first machine learning model.

### CROSS-REFERENCE TO RELATED APPLICATION

This application claims the benefit of and priority to U.S. application Ser. No. 63/378,646 filed Oct. 6, 2022, and entitled “Predictive Maintenance Advisory”, the entire contents of which are incorporated by reference in the present disclosure.

### TECHNICAL FIELD

The present disclosure generally relates to elevator systems, and more particularly, predictive maintenance advisory for elevators.

### BACKGROUND

An elevator may output a large amount of data related to its operation. It may be desirable to predict elevator errors based on this data. Accordingly, a need exists for predictive maintenance advisory for elevators.

### SUMMARY

In one embodiment, a computing devices includes one or more processors. The one or more processors may receive training data comprising elevator data associated with a plurality of elevator assemblies, the elevator data indicating a series of actions performed by an elevator car during a predetermined period of time, receive alert data associated with the plurality of elevator assemblies, the alert data indicating alerts generated by one or more sensors associated with the plurality of elevator assemblies, determine health scores for the plurality of elevator assemblies associated with the training data based on the alert data, label the training data based on the health scores to generate first labeled training data, train a first machine learning model, using the first labeled training data and supervised learning techniques, to predict a health score for an elevator based on input elevator data, receive first elevator data associated with a first elevator, the elevator data indicating a series of actions performed by an elevator car of the first elevator during the predetermined period of time, input the first elevator data into the trained first machine learning model, determine a health score associated with the first elevator based on an output of the first machine learning model, and transmit the determined health score to a technician.

In another embodiment, a method may include receiving training data comprising elevator data associated with a plurality of elevator assemblies, the elevator data indicating a series of actions performed by an elevator car during a predetermined period of time, receiving alert data associated with the plurality of elevator assemblies, the alert data indicating alerts generated by one or more sensors associated with the plurality of elevator assemblies, determining health scores for the plurality of elevator assemblies associated with the training data based on the alert data, labeling the training data based on the health scores to generate first labeled training data, training a first machine learning model, using the first labeled training data and supervised learning techniques, to predict a health score for an elevator based on input elevator data, receiving first elevator data associated with a first elevator, the elevator data indicating a series of actions performed by an elevator car of the first elevator during the predetermined period of time, inputting the first elevator data into the trained first machine learning model, determining a health score associated with the first elevator based on an output of the first machine learning model; and transmitting the determined health score to a technician.

In another embodiment, a system may include an elevator assembly and a computing device. The elevator assembly may include an elevator car. The computing device may include one or more processors. The one or more processors may receive training data comprising elevator data associated with a plurality of elevator assemblies, the elevator data indicating a series of actions performed by an elevator car during a predetermined period of time, receive alert data associated with the plurality of elevator assemblies, the alert data indicating alerts generated by one or more sensors associated with the plurality of elevator assemblies, determine health scores for the plurality of elevator assemblies associated with the training data based on the alert data, label the training data based on the health scores to generate first labeled training data; train a first machine learning model, using the first labeled training data and supervised learning techniques, to predict a health score for an elevator based on input elevator data, receive first elevator data from the elevator assembly, the elevator data indicating a series of actions performed by the elevator car of the elevator assembly during the predetermined period of time, input the first elevator data into the trained first machine learning model, determine a health score associated with the elevator assembly based on an output of the first machine learning model, and transmit the determined health score to a technician.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1A schematically depicts a first aspect of an example elevator assembly schematic, according to one or more embodiments shown and described herein;

FIG. 1B schematically depicts a second aspect of an example elevator assembly schematic, according to one or more embodiments shown and described herein;

FIG. 2 depicts a predictive maintenance advisory system according to one or more embodiments shown and described herein;

FIG. 3 schematically depicts an example remote computing device, according to one or more embodiments shown and described herein;

FIG. 4 depicts a flow chart of an example method for operating the remote computing device of FIG. 3, according to one or more embodiments shown and described herein;

FIG. 5 depicts another flow chart of an example method for operating the remote computing device of FIG. 3, according to one or more embodiments shown and described herein;

FIG. 6 depicts another flow chart of an example method for operating the remote computing device of FIG. 3, according to one or more embodiments shown and described herein; and

FIG. 7 depicts another flow chart of an example method for operating the remote computing device of FIG. 3, according to one or more embodiments shown and described herein.

### DETAILED DESCRIPTION

Embodiments of the present disclosure are directed to predicting when maintenance is needed for elevators. In embodiments, an elevator system may output data associated with its operation. For example, an elevator system may output data indicating when an elevator car is called to a particular floor, when elevator doors open and close, a speed of the elevator doors opening and closing, when an elevator car moves between floors, a speed of the elevator car moving, and the like. The elevator system may also output alerts when one or more errors are detected by sensors or other hardware that are part of an elevator system.

In embodiments, elevator data may be collected from a plurality of elevators over a long time period as training data. The training data may be labeled based on whether a particular sequence of elevator data resulted in any alerts or resulted in any elevator users calling for assistance. The labeled training data may then be used to train a machine learning model to predict a health score for an elevator based on input data associated with the elevator data. In addition, the machine learning model may also be trained to predict a particular floor where elevator maintenance may be needed and/or particular components of the elevator that may be needed. As such, after the model is trained, it may be used to alert to a technician which elevators require maintenance and, in particular, which components of certain elevators require maintenance.

The phrase “communicatively coupled” is used herein to describe the interconnectivity of various components of the monitoring system for elevator assemblies and means that the components are connected either through wires, optical fibers, or wirelessly such that electrical, optical, data, and/or electromagnetic signals may be exchanged between the components. It should be understood that other means of connecting the various components of the system not specifically described herein are included without departing from the scope of the present disclosure.

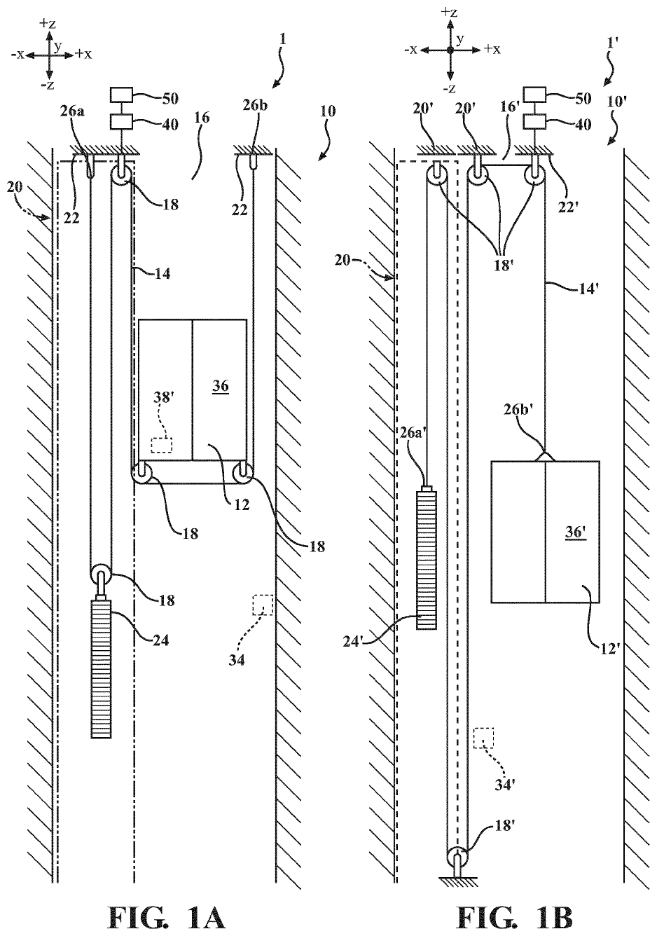

Referring now to the drawings, FIG. 1A depicts an elevator system 1 that includes an elevator assembly schematic that illustrates various components for a first aspect of an example elevator assembly 10. In this aspect, the example elevator assembly 10 may include an elevator car 12, a plurality of elevator hoisting members 14 illustrated for schematic reasons as a single suspension member and herein referred to as hoisting members, a hoistway 16 or elevator shaft, a plurality of sheaves 18, an example frame 20, and a plurality of weights 24 that act as a counterweight to the elevator car 12. The plurality of weights 24 move within the example frame 20 in the system vertical direction (i.e., in the +/−Z direction). The example frame 20 may be an elevator frame, a counterweight elevator frame, and/or the like, as discussed in greater detail herein. The plurality of elevator hoisting members 14 include a distal end 26a and a proximate end 26b. As used herein, the elevator car 12 may be referred to as an elevator car.

Further, in this aspect, as illustrated and without limitation, the example frame 20 includes two sheaves of the plurality of sheaves 18. For example, one sheave is fixedly mounted to an upper portion of the example frame 20 positioned in an upper portion of the hoistway 16 above the elevator car 12 in a vertical direction (i.e., in the +/−Z direction) and another sheave moves with the weights 24 as the elevator car 12 moves between various landings. This is non-limiting, and any number of the plurality of sheaves 18 may be mounted anywhere within the hoistway 16 and there may be more than or less than the two sheaves illustrated as being in the example frame 20.

At least one of the plurality of sheaves 18 within the hoistway 16 may include a motor such that the sheave is a traction sheave capable of driving the plurality of elevator hoisting members 14 through a plurality of lengths between the elevator car 12 and the traction sheave. Further, the plurality of sheaves 18 may further include a plurality of idler sheaves that may also be mounted at various positions in the hoistway 16, and, in this aspect, are also coupled to the elevator car 12. Idler sheaves are passive (they do not drive the elevator hoisting members 14, but rather guide or route the plurality of elevator hoisting members 14) and form a contact point, or engagement point, with the elevator car 12. The plurality of elevator hoisting members 14 and the plurality of sheaves 18 move the elevator car 12 between a plurality of positions within the hoistway 16 including to a plurality of landings. The plurality of sheaves 18 may include any combination of traction type sheaves and idler type sheaves.

The elevator car 12 may include at least one elevator door 36 that is configured to open and close at particular or predetermined landings. Further, in some embodiments, the elevator car 12 may include one or more sensors 38 configured to sense, detect, and/or transmit data respective to the elevator car 12. For example, the one or more sensors 38 may transmit an elevator door position, a position of the elevator car 12 within the hoistway 16, a door trip, and the like, as discussed in greater detail herein.

A plurality of additional sensors 34 may be positioned within the hoistway 16 and configured to monitor the operating conditions of the elevator car 12 and other operating conditions of the elevator assembly 10. The elevator assembly 10 may also include other sensors that may detect operational parameters associated with the elevator car 12 and other components of the elevator assembly 10. In some examples, sensors may detect errors in operation of the elevator car 12, temperature of the hoistway 16, errors in the traction sheaves 18, and the like.

As illustrated in FIG. 1A, the elevator assembly 10 is an underslung elevator system, with the idler sheaves positioned on a bottom surface of the elevator car 12. Each of the plurality of elevator hoisting members 14 may be movably coupled to the traction sheave and a portion of the plurality of elevator hoisting members 14 may be coupled to the bottom surface of the elevator car 12 to suspend the elevator car 12 via the idler sheaves. As such, the elevator hoisting members 14 pass under the elevator car 12 on a bottom of the elevator car 12 via the idler sheaves, and are coupled at the top of the hoistway 16 under tension to various structures, such as to the example frame 20, a plurality of rail caps 22, and/or the like. For example, the proximate end 26b of the plurality of elevator hoisting members 14 may be fixedly coupled to the rail caps 22 and the movably coupled portion of the plurality of elevator hoisting members 14 are under tension to move the elevator car 12 between various landings. The example frame 20 may include a dead end hitch, at least one of the plurality of rail caps 22, or other structural components.

As illustrated in FIG. 1A, the elevator assembly 10 may include a controller 40 and network interface hardware 50. The controller 40 may receive data from the elevator car 12, other elevator components (e.g., each of the plurality of sheaves 18, and the like) and may control operation of the elevator assembly 10. For example, the controller 40 may receive data (e.g., from the plurality of additional sensors 34, the one or more sensors 38, and the like) regarding opening and closing of the at least one elevator door 36 of the elevator car 12, speeds of the opening and closing of the at least one elevator door 36 of the elevator car 12, data regarding movement of the elevator car 12 between floors, speeds of the elevator car 12 moving between different floors, and the like. The controller 40 may also receive data regarding errors detected by various sensors (e.g., from the plurality of additional sensors 34, the one or more sensors 38, and the like) of the elevator assembly 10. The controller 40 may also receive data associated with elevator calls (e.g., when an elevator passenger pushes an elevator button to call the elevator car 12 to a particular floor). In other examples, the controller 40 may receive other data from the elevator car 12 and/or other components of the elevator assembly 10. The controller 40 may also control operation and movement of the elevator car 12. The controller 40 may also receive control signals or data from components remote to the elevator assembly 10.

The network interface hardware 50 may be communicatively coupled to the controller 40. Accordingly, the network interface hardware 50 can include a communication transceiver for sending and/or receiving any wired or wireless communication. For example, the network interface hardware 50 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 50 may receive data about the elevator assembly 10 captured by the controller 40. The network interface hardware 50 may also be communicatively coupled to a remote computing device, as discussed in further detail below.

Referring now to FIG. 1B, a schematic illustrating various components for a second elevator system 1′ that includes a second aspect of an example elevator assembly 10′ is depicted. It should be appreciated that in the discussion herein, the elevator assembly 10, and components thereof, may refer to either elevator assembly 10, 10′. In this aspect, the elevator assembly 10′ may include an elevator car 12′, a plurality of elevator hoisting members 14′ illustrated for schematic reasons as a single suspension member, a hoistway 16′ or elevator shaft, a plurality of sheaves 18′, such as traction sheaves and/or idler sheaves, an example grounded frame 20′, and a plurality of weights 24′ that move within the example frame 20′ in the system vertical direction (i.e., in the +/−Z direction). In this aspect, the plurality of elevator hoisting members 14′extend a length between the weights 24′ and the elevator car 12′. Further, in this aspect, at least one of the plurality of sheaves 18′ is a traction sheave, which, for example, may be mounted to a lower surface of the hoistway 16′. This is non-limiting, and the traction sheave of the plurality of sheaves 18′ may be mounted anywhere within the hoistway 16′ and the plurality of sheaves 18′ may include a plurality of idler sheaves and at least one traction sheave. It should be appreciated that the traction sheave may include a motor such that at least one of the plurality of sheaves 18′ is a device to drive the plurality of elevator hoisting members 14′ through a plurality of lengths with respect to the length between the traction sheave and the contact point of the elevator car 12′. The idler sheaves may also be mounted at various positions in the hoistway 16′ including within the example frame 20′. The idler sheaves are passive (they do not drive the plurality of elevator hoisting members 14′ but rather guide or route the plurality of elevator hoisting members 14′). The plurality of elevator hoisting members 14′ are coupled to the elevator car 12′ to form the contact point. At least one temperature sensor 34′ may be positioned within the hoistway 16′. The at least one temperature sensor 34′ may output data indicative to a temperature within the hoistway 16′. The elevator assembly 10′ may also include the controller 40 and the network interface hardware 50.

It should be appreciated that the illustrated schematics of FIGS. 1A-1B are merely examples and that the plurality of elevator hoisting members 14 routing may vary significantly or slightly from these illustrated schematics. For example, there may be several idler sheaves positioned in the hoistway 16 between the traction sheave and the contact point with the elevator car 12.

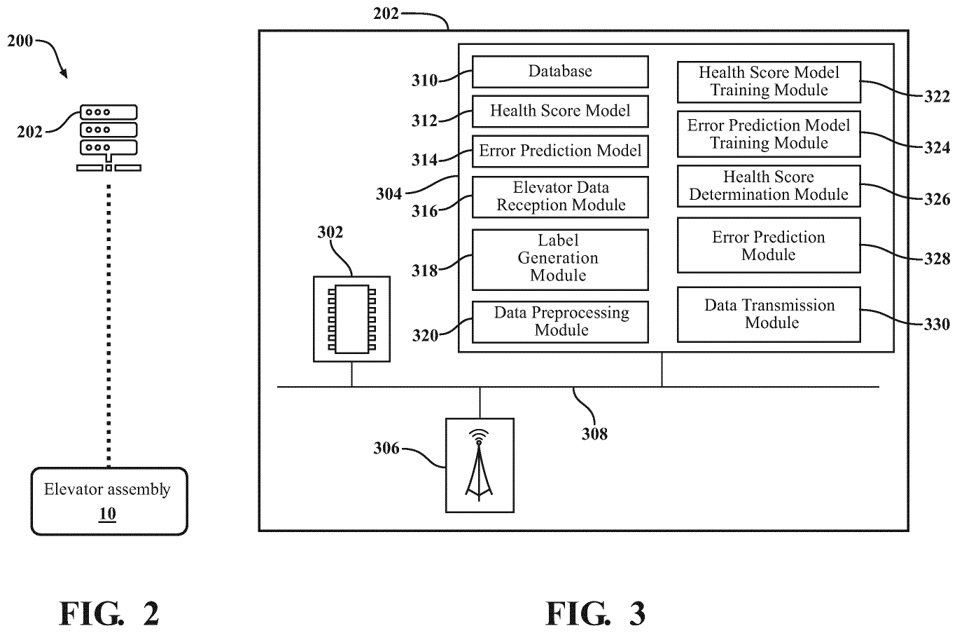

Referring now to FIG. 2, a predictive maintenance advisory system 200 is shown. The predictive maintenance advisory system 200 includes a remote computing device 202 and the elevator assembly 10 of FIG. 1A. However, in some examples, the predictive maintenance advisory system 200 may include the elevator assembly 10′ of FIG. 1B instead of the elevator assembly 10 of FIG. 1A, and/or other elevator assemblies not illustrated. The remote computing device 202 may be communicatively coupled to the elevator assembly 10. In particular, the remote computing device 202 may be communicatively coupled to the network interface hardware 50 of FIG. 1A. In the illustrated example, the remote computing device 202 includes a cloud computing server. However, in other examples, the remote computing device 202 may be any other type of computing system. In the illustrated example, the remote computing device 202 is located remotely from the elevator assembly 10. However, in other examples, the remote computing device 202 may be located in the same location as the elevator assembly 10 (e.g., in the same building as the elevator assembly 10). While the remote computing device 202 is shown as being communicatively coupled to one elevator assembly for purposes of illustration, in actuality the remote computing device 202 may be communicatively coupled to a plurality of elevator assemblies and/or to a plurality of elevator systems that include various elevator assemblies, and as such, may receive data from multiple elevator assemblies and/or elevator systems, as disclosed herein. The remote computing device 202 is described in further detail below.

Now referring to FIG. 3, the remote computing device 202 is schematically depicted. In the example of FIG. 3, the remote computing device 202 includes one or more processors 302, one or more memory modules 304, network interface hardware 306, and a communication path 308. The one or more processors 302 may be a controller, an integrated circuit, a microchip, a computer, a central processing unit (CPU), or any other computing device. The one or more memory modules 304 may include RAM, ROM, flash memories, hard drives, or any device capable of storing machine readable and executable instructions such that the machine readable and executable instructions can be accessed by the one or more processors 302.

The network interface hardware 306 can be communicatively coupled to the communication path 308 and can be any device capable of transmitting and/or receiving data via a network. Accordingly, the network interface hardware 306 can include a communication transceiver for sending and/or receiving any wired or wireless communication. For example, the network interface hardware 306 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 306 of the remote computing device 202 may transmit data to and receive data from the elevator assembly 10. For example, the network interface hardware 306 of the remote computing device 202 may be communicatively coupled to the network interface hardware 50 of the elevator assembly 10.

The one or more memory modules 304 include a database 310, a health score model 312, an error prediction model 314, an elevator data reception module 316, a label generation module 318, a data preprocessing module 320, a health score model training module 322, an error prediction model training module 324, a health score determination module 326, an error prediction module 328, and a data transmission module 330. Each of the database 310, the health score model 312, the error prediction model 314, the elevator data reception module 316, the label generation module 318, the data preprocessing module 320, the health score model training module 322, the error prediction model training module 324, the health score determination module 326, the error prediction module 328, and the data transmission module 330 may each be or the combination be a program module in the form of operating systems, application program modules, and other program modules stored in the one or more memory modules 304 (e.g., each of which may be embodied as a computer program, firmware, or hardware, as an example). In some embodiments, the program module may be stored in a remote storage device that may communicate with the remote computing device 202. Such a program module may include, but is not limited to, routines, subroutines, programs, objects, components, data structures and the like for performing specific tasks or executing specific data types as will be described below.

The database 310 may store data received from elevators, such as the various components of the elevator assembly 10. The database 310 may also store other data that may be used by the one or more memory modules 304.

The health score model 312 may store parameters associated with a machine learning model for predicting health scores, and the error prediction model 314 may store parameters associated with a machine learning model for making error predictions, as disclosed herein. In embodiments, the remote computing device 202 may maintain the health score model 312 and the error prediction model 314. Both of these models may be machine learning models (e.g., neural networks), and may be trained by the remote computing device 202 as discussed in further detail below.

The health score model 312 may receive data associated with the elevator assembly 10 as input and may output a predicted health score. The health score may provide an indication as to the health of the various components of the elevator system (e.g., the elevator car 12, the at least one elevator door 36, the traction sheave 18, and the like, depicted in FIG. 1A). For example, a high health score may indicate that little or no maintenance needs to be performed on the components of the elevator assembly 10 (FIG. 1A), whereas a low health score may indicate that significant maintenance needs to be performed on one or more components of the elevator assembly 10 (FIG. 1A). In some examples, a low health score may indicate that little or no maintenance needs to be performed on one or more components of the elevator assembly 10 (FIG. 1A), whereas a high health score may indicate that significant maintenance needs to be performed on one or more components of the elevator assembly 10 (FIG. 1A). In the illustrated example, a health score associated with an elevator may range between 0 and 1. However, in other examples, a health score may have any other range.

The error prediction model 314 may receive data associated with one or more components of the elevator assembly 10 (FIG. 1A) as input and may output a prediction as to the specific components of the elevator assembly 10 (FIG. 1A) that need maintenance. This may allow a technician to more quickly perform elevator maintenance by immediately addressing specific elevator components that are most likely to need maintenance. The health score model 312 and the error prediction model 314 are discussed in further detail below.

Referring still to FIG. 3, the elevator data reception module 316 may receive data from the elevator car 12 (FIG. 1A) or from other components of the elevator assembly 10 (FIG. 1A). In the illustrated example, the elevator data reception module 316 may receive elevator data from the network interface hardware 50 (FIG. 1A) that has been received from the controller 40 (FIG. 1A). The data received by the elevator data reception module 316 may indicate actions or operations performed by the elevator car 12 (FIG. 1A) and/or the elevator assembly 10 (FIG. 1A) during a predetermined interval of time. As discussed above, the data received by the elevator data reception module 316 may include data about elevator calls, opening and closing of the at least one elevator door 36 (FIG. 1A), movement of an elevator between floors or landings, speeds of the at least one elevator door 36 while opening and closing, speeds of the elevator car 12 while moving between floors or landings, alerts generated by one or more elevator sensors (e.g., the one or more sensors 38, the plurality of additional sensors 34, and the like, schematically depicted in FIG. 1A), and other data associated with elevator operation. The elevator data reception module 316 may also receive information about callbacks (e.g., when an elevator user requests assistance, and an operator calls the user back) and alerts detected by elevator sensors (e.g., the one or more sensors 38, the plurality of additional sensors 34, and the like, schematically depicted in FIG. 1A). The information about callbacks and alerts may be used to generate labels for training data, as discussed in further detail below.

The elevator data reception module 316 may receive elevator data during training and during real-time operation, as disclosed herein. During training, the elevator data reception module 316 may receive training data from a plurality of elevator systems 1 (e.g., more than one of the elevator assembly 10 schematically depicted in FIG. 1A), which may be used to train the health score model 312 and/or the error prediction model 314, as disclosed herein. After the models are trained, the elevator data reception module 316 may receive elevator data in real-time (e.g., from the one or more sensors 38, the plurality of additional sensors 34, and the like, from each of the elevator assemblies 10, schematically depicted in FIG. 1A). The real-time data may then be input into the trained health score model 312 to predict a health score and/or the trained error prediction model 314 to predict specific components that may need maintenance, as discussed in further detail below.

During training, the elevator data reception module 316 may receive training data from the plurality of elevator systems 1 (e.g., more than one of the elevator assembly 10 schematically depicted in FIG. 1A). The training data may include a plurality of training examples, in which each training example includes elevator data associated with a particular elevator over a predetermined period of time. As discussed above, the elevator data may include data associated with operation of an elevator. In the illustrated example, a training example may include elevator data associated with a particular elevator over three-month period of time. However, in other examples, a training example may include elevator data associated with a particular elevator over any other period of time. In embodiments, the elevator data reception module 316 may receive a large number of training examples from a variety of different elevators in order to better train the models.

In embodiments, the elevator data reception module 316 may also receive ground truth data that may be used to label the training examples. The labeled training examples may then be used to train the respective models. For the health score model 312, the ground truth data may include alert data associated with the elevator assembly 10 (e.g., one or more of the more than one of the elevator assembly 10 schematically depicted in FIG. 1A) as well as callback data associated with the elevator assembly 10 (FIG. 1A). The alert data may include alerts generated by the elevator assembly 10 (FIG. 1A). In particular, as discussed above, the elevator assembly 10 (FIG. 1A) may include one or more sensors that detect errors associated with one or more components of the elevator assembly 10 (e.g., the one or more sensors 38, the plurality of additional sensors 34, and the like, schematically depicted in FIG. 1A) and generate alerts when the errors are detected. As such, the elevator data reception module 316 may receive data indicating time stamps when different alerts are generated. In addition, elevator users may report issues with the elevator assembly 10 (FIG. 1A), which may result in a callback to address the issue. The elevator data reception module 316 may also receive data about these callbacks. The alert data and the callback data may be used to label the training data associated with the health score model 312, as discussed in further detail below.

For the error prediction model 314, the ground truth data may include data about particular components that require maintenance. For example, when a technician visits the elevator assembly 10 (FIG. 1A) for a maintenance visit, the technician may note that certain components that require maintenance. The technician may log the components requiring maintenance and this data may be stored. Then, when the elevator assembly 10 (FIG. 1A) transmits training data to the remote computing device 202, the elevator assembly 10 (FIG. 1A) may transmit an indication of the particular components requiring maintenance during a maintenance visit, as well as elevator data during a predetermined period of time leading up to the maintenance visit (e.g., during the previous three-months). The elevator data and the associated ground truth data about components requiring maintenance may comprise a training example. In some examples, the elevator assembly 10 (FIG. 1A) may also transmit data indicating a specific floor upon which elevator maintenance was needed. This data may also be included as ground truth data. A plurality of such training examples may be used to train the error prediction model 314, as discussed in further detail below.

During real-time operation, the elevator data reception module 316 may receive real-time elevator data from the elevator assembly 10 (e.g., data generated from the one or more sensors 38, the plurality of additional sensors 34, and the like, schematically depicted in FIG. 1A). The received elevator data may then be input into the trained health score model 312 and/or the trained error prediction model 314 to predict a health score and/or elevator components needing maintenance, respectively.

Referring still to FIG. 3, the label generation module 318 may generate labels to be used to train the health score model 312 and the error prediction model 314, as disclosed herein. As discussed above, the elevator data reception module 316 may receive training data including elevator data over a predetermined time period as well as ground truth data associated with the training data. The label generation module 318 may generate labels to be used for model training based on the ground truth data.

As discussed above, the health score model 312 may output a health score for the elevator assembly 10 itself, or for various components of the elevator assembly 10 (e.g., elevator car 12, the at least one elevator door 36, traction sheaves 18, and the like) based on input elevator data. As such, during training of the health score model 312, training examples may include ground truth health scores. In the illustrated example, a ground truth health score associated with the elevator assembly 10 (FIG. 1A) is based on alert data and callback data. Accordingly, in embodiments, the label generation module 318 may generate a label for a training example based on the alert data and the callback data received by the elevator data reception module 316.

In some examples, the label generation module 318 may utilize a mathematical formula to determine a ground truth health score for a training example. In some examples, the ground truth health score may be based on the types of alerts included in the alert data (e.g., some alerts may be weighted more heavily than other alerts). In some examples, the ground truth health score may be based on when the alerts were generated (e.g., alerts generated earlier in a training example may be weighted less than alerts generated later in a training example). In some examples, the ground truth health score may be determined on a frequency of alerts or a number of times that a particular alert is generated. In some examples, the ground truth health score may be based on when callbacks are generated or the type of information generated in a callback (e.g., what elevator issues triggered the callback).

In embodiments, the label generation module 318 may determine a ground truth health score for each training example based on the received alert data and callback data. The label generation module 318 may then label each training example with the determined ground truth health score. The labeled training examples may then be used to train the health score model 312, as discussed in further detail below.

With respect to the error prediction model 314, as discussed above, the error prediction model 314 may predict specific elevator components experiencing errors or needing maintenance based on input elevator data. Accordingly, during training of the error prediction model 314, the training examples may include ground truth data indicating specific components needing maintenance and/or specific floors for which maintenance was required. As discussed above, this ground truth data may be received by the elevator data reception module 316. As such, the label generation module 318 may label each of the training examples received by the elevator data reception module 316 with the ground truth data indicating the elevator components needing maintenance or the elevator floors needing maintenance. The labeled training examples may then be used to train the error prediction model 314, as discussed in further detail below.

Referring still to FIG. 3, the data preprocessing module 320 may preprocess elevator data received by the elevator data reception module 316, as disclosed herein. In particular, the data preprocessing module 320 may generate features based on the received elevator data by implementing, for example, aggregation, grouping, filtering, scaling, multiplication, or other transformations of the raw elevator data received from one or more elevator assemblies 10. The data preprocessing module 320 may generate features to weight certain types of elevator data more than other types of elevator data. In some examples, subject matter experts may determine how features should be determined based on the elevator data. Features may be selected to optimally reflect actual elevator behavior and operational characteristics, and to separate good conditions from bad conditions. In embodiments, after the data preprocessing module 320 generates features based on received elevator data, the features may be input into the models, as disclosed herein. As such, once trained, machine learning may be utilized to determine how features should be determined based on the elevator data.

Referring still to FIG. 3, the health score model training module 322 may train the health score model 312 maintained by the remote computing device 202. As discussed above, the health score model 312 may be trained to receive elevator data (or features there) as input and output a predicted health score based on the input data. Accordingly, the health score model training module 322 may perform training of the health score model 312, as disclosed herein.

As discussed above, the elevator data reception module 316 may receive training data comprising a plurality of training examples. Each training example may include elevator data associated with the elevator assembly 10 (FIG. 1A) over a predetermined period of time as well as alert data and callback data. As discussed above, the label generation module 318 may generate labels associated with each training example based on the alert data and callback data. As also discussed above, the data preprocessing module 320 may generate features based on the elevator data of the training examples.

After the label generation module 318 generates labels for the training example, and the data preprocessing module 320 generates features based on the elevator data of the training examples, the health score model training module 322 may train the health score model 312 using supervised learning techniques. In the illustrated example, the health score model 312 includes a neural network. However, in other examples, the health score model 312 may be any other type of machine learning model. In the illustrated example, the health score model 312 may include a neural network having any number of hidden layers and any number of nodes in each layer.

In embodiments, the health score model training module 322 may input the features associated with each training example generated by the data preprocessing module 320 into the health score model 312, which may initially be set to have random weights as parameters. The health score model 312 may then output a predicted health score for each training example and the health score model training module 322 may determine a value of a loss function associated with each training example. In particular, the loss function for a training example may be based on a difference between the predicted health score output by the health score model 312 and the ground truth health score for the training example assigned by the label generation module 318.

After the health score model training module 322 determines a loss value for each training example, the health score model training module 322 may determine a value of an overall cost function by combining the loss values for all of the training examples. The health score model training module 322 may then update the weights of the health score model 312 to reduce the cost using a known optimization method (e.g., gradient descent). The health score model training module 322 may iteratively perform this process for a predetermined number of iterations or until the cost is below a predetermined threshold. The final determined weights may be stored in the database 310 as the parameters of the trained health score model 312. The trained health score model 312 may then be used to predict a health score for the elevator assembly 10 (FIG. 1A) based on real-time elevator data, as disclosed in further detail below.

Referring still to FIG. 3, the error prediction model training module 324 may train the error prediction model 314, as disclosed herein. As discussed above, the error prediction model 314 may be trained to receive elevator data as an input and output a prediction as to what components of the elevator need maintenance. In some examples, the error prediction model 314 may be trained to output a predicted floor associated with the elevator that needs maintenance.

As discussed above, the label generation module 318 may generate labels for training examples that include ground truth values of components that required maintenance (e.g., based on actual maintenance visits). After the label generation module 318 generates the training examples and the data preprocessing module 320 generates features associated with the training examples, the error prediction model training module 324 may input the features into the error prediction model 314.

In the illustrated example, the error prediction model 314 may be a neural network. However, in other examples, the error prediction model 314 may be any other type of machine learning model. In embodiments, the error prediction model 314 may be initialized with random parameters (e.g., weights of neural network nodes), and may then be trained using supervised learning techniques. In particular, the error prediction model training module 324 may train the error prediction model 314 to classify the input data and predict elevator components and/or elevator floors that need maintenance. After the error prediction model 314 is trained, the trained error prediction model 314 may be used to predict elevator components that need maintenance based on real-time elevator data, as disclosed in further detail below.

Referring still to FIG. 3, the health score determination module 326 may use the trained health score model 312 to determine a health score for the elevator assembly 10 (FIG. 1A) based on real-time elevator data. In embodiments, after the health score model 312 is trained as discussed above, the elevator data reception module 316 may receive real-time elevator data from an elevator (e.g., from the elevator assembly 10). The received real-time data may include elevator data associated with the elevator assembly 10 (FIG. 1A) during a predetermined period (e.g., during the previous three-months). The data preprocessing module 320 may process the received elevator data to generate features. The health score determination module 326 may then input the features into the trained health score model 312. The trained health score model 312 may then output a predicted health score based on the input elevator data. As such, the health score determination module 326 may determine a real-time health score for the elevator assembly 10 (FIG. 1A) itself and/or various components of the elevator assembly 10 (e.g., the elevator car 12, the at least one elevator door 36, the traction sheave 18, and the like, as schematically depicted in FIG. 1A).

Referring still to FIG. 3, the error prediction module 328 may use the trained error prediction model 314 to determine components of the elevator assembly 10 (FIG. 1A) that may require maintenance based on real-time elevator data. In embodiments, after the error prediction model 314 is trained as discussed above, the elevator data reception module 316 may receive real-time elevator data from an elevator (e.g., from the elevator assembly 10). The received real-time data may comprise elevator data associated with the elevator during a predetermined period (e.g., during the previous three-months). The data preprocessing module 320 may process the received elevator data to generate features. The error prediction module 328 may then input the features into the trained error prediction model 314. The trained error prediction model 314 may then output specific elevator components and/or elevator floors for which maintenance may be needed. As such, the error prediction module 328 may determine elevator components needing maintenance in real-time.

Referring still to FIG. 3, the data transmission module 330 may transmit data determined by the health score determination module 326 and/or the error prediction module 328 to an operator or other entity associated with an elevator. For example, the data transmission module 330 may transmit this data to a technician who may perform elevator maintenance. In one example, the data transmission module 330 may transmit health score data associated with a large number of elevators to a technician. The data transmission module 330 may also transmit data about the elevator components of those elevators expected to need maintenance (e.g., health score for many components from each elevator assembly 10 of the plurality of elevator assemblies). As such, the technician may prioritize maintenance of elevator assemblies 10 (FIG. 1A) having a lower health score (e.g., more likely to need maintenance) over elevator assemblies 10 (FIG. 1A) having a higher health score (e.g., less likely to need maintenance). Furthermore, during a maintenance visit, the technician may focus on the elevator components predicted to need maintenance. This may increase the efficiency of elevator maintenance, reduce costs, minimize down time of the elevator assembly 10 (FIG. 1A), and the like.

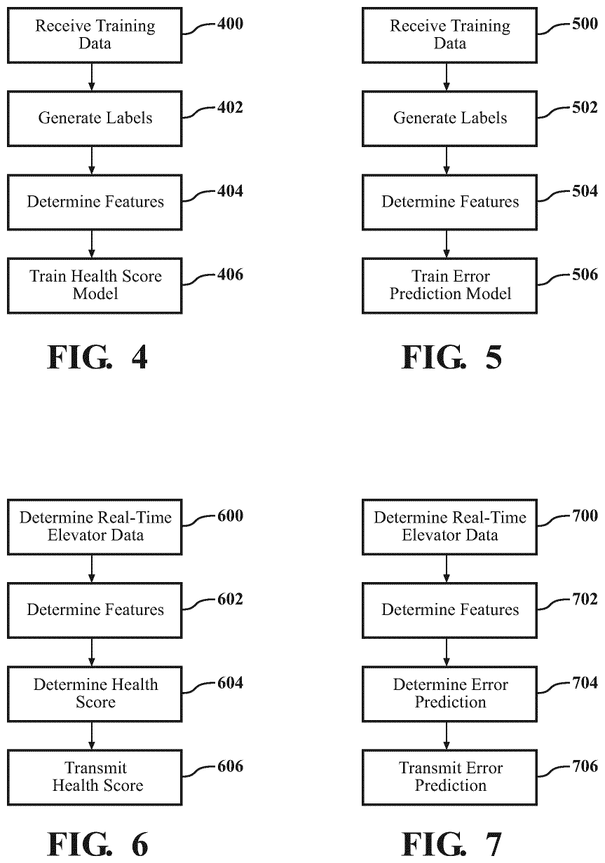

Turning now to FIG. 4, a flow chart is depicted of an example method that may be performed by the remote computing device 202 to train the health score model 312. Although the steps associated with the blocks of FIG. 4 will be described as being separate tasks, in other embodiments, the blocks may be combined or omitted. Further, while the steps associated with the blocks of FIG. 4 are described as being performed in a particular order, in other embodiments, the steps may be performed in a different order.

At step 400, the elevator data reception module 316 receives training data. As discussed above, the training data may include elevator data from a plurality of elevator assemblies over a predetermined time period as well as alert data and callback data.

At step 402, the label generation module 318 generates labels for the training data received by the elevator data reception module 316. As discussed above, the label generation module 318 may generate labels including ground truth values based on the alert data and callback data received by the elevator data reception module 316.

At step 404, the data preprocessing module 320 may perform data preprocessing to determine features associated with the received training data. Then at step 406, the health score model training module 322 may train the health score model 312 using the supervised learning techniques discussed above. In particular, the health score model training module 322 may train the health score model 312 to receive elevator data as an input and to output a predicted health score for the elevator associated with the elevator data.

Turning now to FIG. 5, a flow chart is depicted of an example method that may be performed by the remote computing device 202 to train the error prediction model 314. Although the steps associated with the blocks of FIG. 5 will be described as being separate tasks, in other embodiments, the blocks may be combined or omitted. Further, while the steps associated with the blocks of FIG. 5 are described as being performed in a particular order, in other embodiments, the steps may be performed in a different order.

At step 500, the elevator data reception module 316 receives training data. As discussed above, the training data may include elevator data from a plurality of elevator assemblies over a predetermined time period as well as alert data and callback data.

At step 502, the label generation module 318 generates labels for the training data received by the elevator data reception module 316. As discussed above, the label generation module 318 may generate labels including ground truth values based on actual elevator components needing maintenance during maintenance visits, as received by the elevator data reception module 316.

At step 504, the data preprocessing module 320 may perform data preprocessing to determine features associated with the received training data. Then at step 506, the error prediction model training module 324 may train the error prediction model 314 using the supervised learning techniques discussed above. In particular, the error prediction model training module 324 may train the error prediction model 314 to receive elevator data as an input and to output elevator components needing maintenance and/or an elevator floor or landing needing maintenance.

Turning now to FIG. 6, a flow chart is depicted of an example method that may be performed by the remote computing device 202 to determine a health score for an elevator during real-time operation. Although the steps associated with the blocks of FIG. 6 will be described as being separate tasks, in other embodiments, the blocks may be combined or omitted. Further, while the steps associated with the blocks of FIG. 6 are described as being performed in a particular order, in other embodiments, the steps may be performed in a different order.

At step 600, the elevator data reception module 316 receives real-time elevator data. As discussed above, the real-time elevator data may be received from a particular elevator (e.g., the elevator assembly 10) and may include elevator operations performed by the elevator assembly 10 over a predetermined time period.

At step 602, the data preprocessing module 320 may perform data preprocessing to determine features associated with the received elevator data. At step 604, the health score determination module 326 may input the features into the trained health score model 312 and may determine a health score for the elevator based on the output of the model. Then at step 606, the data transmission module 330 may transmit the determined health score to a technician and/or other individuals associated with the elevator assembly 10. In some examples, the method of FIG. 6 may be performed every day to determine a daily health score for the elevator. However, in other examples, the method of FIG. 6 may be performed at other intervals or may be continuously performed.

Turning now to FIG. 7, a flow chart is depicted of an example method that may be performed by the remote computing device 202 to determine components of an elevator needing maintenance during real-time operation. Although the steps associated with the blocks of FIG. 7 will be described as being separate tasks, in other embodiments, the blocks may be combined or omitted. Further, while the steps associated with the blocks of FIG. 7 are described as being performed in a particular order, in other embodiments, the steps may be performed in a different order.

At step 700, the elevator data reception module 316 receives real-time elevator data. As discussed above, the real-time elevator data may be received from a particular elevator (e.g., the elevator assembly 10) and may include elevator operations performed by the elevator over a predetermined time period.

At step 702, the data preprocessing module 320 may perform data preprocessing to determine features associated with the received elevator data. At step 704, the error prediction module 328 may input the features into the trained error prediction model 314 and may determine an error prediction specifying components of the elevator and/or floors of the elevator needing maintenance. Then at step 706, the data transmission module 330 may transmit the determined components to a technician and/or other individuals associated with the elevator assembly 10.

It should now be understood that embodiments disclosed herein provide predictive maintenance advisory for elevators. The embodiments disclosed herein may maintain two machine learning models, one model to determine a health score for an elevator and one model to determine elevator components needing maintenance. The models may be trained on a large amount historical elevator data from a variety of elevators to make the models robust for different inputs. After the models are trained, the trained models may be used to provide real-time indications of elevator health scores and elevator components needing maintenance. This may provide technicians with information on which elevators to prioritize for maintenance and which components to service during maintenance visits.

After a technician performs a maintenance visit, the technician may provide additional information about the health of the elevator and whether the components indicated as needing service actually needed service. This information may be used to further train and improve the models. In addition, after a technician performs maintenance on an elevator, the elevator may be monitored to determine whether the health score of the elevator improves. This information may also be used to further train and improve the models.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computing device comprising one or more processors configured to:
receive training data comprising elevator data associated with a plurality of elevator assemblies, the elevator data indicating a series of actions performed by an elevator car during a predetermined period of time;
receive alert data associated with the plurality of elevator assemblies, the alert data indicating alerts generated by one or more sensors associated with the plurality of elevator assemblies;
determine health scores for the plurality of elevator assemblies associated with the training data based on the alert data;
label the training data based on the health scores to generate first labeled training data;
train a first machine learning model, using the first labeled training data and supervised learning techniques, to predict a health score for an elevator based on input elevator data;
receive first elevator data associated with a first elevator, the elevator data indicating a series of actions performed by an elevator car of the first elevator during the predetermined period of time;
input the first elevator data into the trained first machine learning model;
determine a health score associated with the first elevator based on an output of the first machine learning model; and
transmit the determined health score to a technician.

2. The computing device of claim 1, wherein the one or more processors are further configured to:
receive callback data associated with the plurality of elevator assemblies, the callback data indicating requests for service from an elevator user; and
and determine the health scores for the plurality of elevator assemblies associated with the training data based on the alert data and the callback data.

3. The computing device of claim 1, wherein the one or more processors are further configured to:
generate features based on the training data; and
train the first machine learning model based on the generated features.

4. The computing device of claim 1, wherein the one or more processors are further configured to:
receive ground truth data indicating elevator components requiring maintenance for the plurality of elevator assemblies;
label the training data based on the ground truth data to generate second labeled training data; and
train a second machine learning model, using the second labeled training data and supervised learning techniques, to predict elevator components needing maintenance based on input elevator data.

5. The computing device of claim 1, wherein the one or more processors are further configured to:
receive ground truth data indicating an elevator floor where elevator maintenance is needed for the plurality of elevator assemblies;
label the training data based on the ground truth data to generate second labeled training data; and
train a second machine learning model, using the second labeled training data and supervised learning techniques, to predict an elevator landing where elevator maintenance is needed based on input elevator data.

6. The computing device of claim 4, wherein the one or more processors are further configured to:
input the first elevator data into the trained second machine learning model; and
determine components of the first elevator needing maintenance based on an output of the second machine learning model.

7. The computing device of claim 5, wherein the one or more processors are further configured to:
input the first elevator data into the trained second machine learning model; and
determine an elevator landing where maintenance is needed based on an output of the second machine learning model.

8. A method comprising:
receiving training data comprising elevator data associated with a plurality of elevator assemblies, the elevator data indicating a series of actions performed by an elevator car during a predetermined period of time;
receiving alert data associated with the plurality of elevator assemblies, the alert data indicating alerts generated by one or more sensors associated with the plurality of elevator assemblies;
determining health scores for the plurality of elevator assemblies associated with the training data based on the alert data;
labeling the training data based on the health scores to generate first labeled training data;
training a first machine learning model, using the first labeled training data and supervised learning techniques, to predict a health score for an elevator based on input elevator data;
receiving first elevator data associated with a first elevator, the elevator data indicating a series of actions performed by an elevator car of the first elevator during the predetermined period of time;
inputting the first elevator data into the trained first machine learning model;
determining a health score associated with the first elevator based on an output of the first machine learning model; and
transmitting the determined health score to a technician.

9. The method of claim 8, further comprising:
receiving callback data associated with the plurality of elevator assemblies, the callback data indicating requests for service from an elevator user; and
and determining the health scores for the plurality of elevator assemblies associated with the training data based on the alert data and the callback data.

10. The method of claim 8, further comprising:
generating features based on the training data; and
training the first machine learning model based on the generated features.

11. The method of claim 8, further comprising:
receiving ground truth data indicating elevator components requiring maintenance for the plurality of elevator assemblies;
labeling the training data based on the ground truth data to generate second labeled training data; and
training a second machine learning model, using the second labeled training data and supervised learning techniques, to predict elevator components needing maintenance based on input elevator data.

12. The method of claim 8, further comprising:
receiving ground truth data indicating an elevator floor where elevator maintenance is needed for the plurality of elevator assemblies;
labeling the training data based on the ground truth data to generate second labeled training data; and
training a second machine learning model, using the second labeled training data and supervised learning techniques, to predict an elevator landing where elevator maintenance is needed based on input elevator data.

13. The method of claim 11, further comprising:
inputting the first elevator data into the trained second machine learning model; and
determining components of the first elevator needing maintenance based on an output of the second machine learning model.

14. The method of claim 12, further comprising:
receiving real-time elevator data associated with a first elevator;
inputting the first elevator data into the trained second machine learning model; and
determining an elevator landing where maintenance is needed for the first elevator based on an output of the second machine learning model.

15. A system comprising:
an elevator assembly comprising an elevator car; and
a computing device comprising one or more processors configured to:
receive training data comprising elevator data associated with a plurality of elevator assemblies, the elevator data indicating a series of actions performed by an elevator car during a predetermined period of time;
receive alert data associated with the plurality of elevator assemblies, the alert data indicating alerts generated by one or more sensors associated with the plurality of elevator assemblies;
determine health scores for the plurality of elevator assemblies associated with the training data based on the alert data;
label the training data based on the health scores to generate first labeled training data; train a first machine learning model, using the first labeled training data and supervised learning techniques, to predict a health score for an elevator based on input elevator data;
receive first elevator data from the elevator assembly, the elevator data indicating a series of actions performed by the elevator car of the elevator assembly during the predetermined period of time;
input the first elevator data into the trained first machine learning model;
determine a health score associated with the elevator assembly based on an output of the first machine learning model; and
transmit the determined health score to a technician.

16. The system of claim 15, wherein the one or more processors are further configured to:
receive callback data associated with the plurality of elevator assemblies, the callback data indicating requests for service from an elevator user; and
and determine the health scores for the plurality of elevator assemblies associated with the training data based on the alert data and the callback data.

17. The system of claim 15, wherein the one or more processors are further configured to:
generate features based on the training data; and
train the first machine learning model based on the generated features.

18. The system of claim 15, wherein the one or more processors are further configured to:
receive ground truth data indicating elevator components requiring maintenance for the plurality of elevator assemblies;
label the training data based on the ground truth data to generate second labeled training data; and
train a second machine learning model, using the second labeled training data and supervised learning techniques, to predict elevator components needing maintenance based on input elevator data.

19. The system of claim 15, wherein the one or more processors are further configured to:
receive ground truth data indicating an elevator floor where elevator maintenance is needed for the plurality of elevator assemblies;
label the training data based on the ground truth data to generate second labeled training data; and
train a second machine learning model, using the second labeled training data and supervised learning techniques, to predict an elevator landing where elevator maintenance is needed based on input elevator data.

20. The system of claim 18, wherein the one or more processors are further configured to:
input the first elevator data into the trained second machine learning model; and
determine components of the first elevator needing maintenance based on an output of the second machine learning model.
